(19) United States
(12) Patent Application Publication
(10) Pub. No.: US 2026/0368950 A1
(43) Pub. Date: Nov. 19, 2026

(54) SEMICONDUCTOR DEFECT DETECTION DEVICE

(71) Applicant: Samsung Electronics Co., Ltd., Suwon-si (KR)

(72) Inventors: YoungJoo Kim, Suwon-si (KR); Do-Nyun Kim, Seoul (KR); Joowoo Kim, Suwon-si (KR); Jong Keun Moon, Suwon-si (KR); Musang You, Suwon-si (KR); Yun Hyoung Nam, Seoul (KR); Jeongmin Lee, Seoul (KR)

(73) Assignee: Seoul National University R&DB Foundation, Seoul (KR)

(21) Appl. No.: 19/679,289

(22) Filed: May 15, 2026

(30) Foreign Application Priority Data
May 16, 2025 (KR) 10-2025-0064182

(51) Int. Cl. G06T 11/00; G06T 7/00

(52) U.S. Cl. CPC G06T 11/00; G06T 7/001; G06T 2207/30148

(57) ABSTRACT

A detect detection device including a memory and a processor, where the processor includes a feature extractor that generates a feature vector by using an information about a defect as an input value; a feature splitter that generates a mask defining the defect by using the feature vector as an input value; and an image generating unit for generating a normal image and an image including a semiconductor defect from the mask.

### CROSS-REFERENCE TO RELATED APPLICATION

This application claims priority to and the benefit of Korean Patent Application No. 10-2025-0064182 filed with the Korean Intellectual Property Office on May 16, 2025, the entire contents of which are incorporated herein by reference.

### BACKGROUND

The technical idea of the present disclosure relates to a device for identifying a semiconductor defect, and more specifically, to a defect detection device.

Semiconductors are manufactured through various types of processes. As a semiconductor design technology advances, the number of processes for manufacturing the semiconductor increases, thereby increasing a complexity thereof. As the number and the complexity of the semiconductor processes increase, various defects may occur in the semiconductor manufacturing process.

In order to identify and correct the causes of a semiconductor defects, the semiconductor defects can be detected first. In some examples, a visual method is used to detect the defects in the semiconductors. The visual method classifies the defects in the semiconductors based on the images of the semiconductors. However, when performing the visual method manually, the accuracy and reliability may vary depending on the skill level of the manager.

### SUMMARY

A semiconductor automatic defect classification (ADC) may be used in a semiconductor manufacturing process and may include a process of transferring a circuit pattern to a wafer to create micrometer or nanometer-scale detailed circuits and then inspecting the created circuits for defects. The semiconductor automatic defect classification can enable determining the performance and quality of the semiconductors.

Automatic semiconductor defect classification may be based on an artificial intelligence model. Specifically, the semiconductor automatic defect classification utilizing the artificial intelligence model may be trained on training data. While relatively many normal semiconductor images may be acquired through a measurement, only a very small number of the semiconductor defect images are available based on their type. Accordingly, the semiconductor defect images may take considerable effort and time to acquire.

The present disclosure provides a defect detection device that provides faster results and saves a time and a cost compared to traditional defect detection methods.

The present disclosure provides a defect detection device that generates various types of defect images based on a small amount of defect images, thereby reducing a repetitive measurement work.

The present disclosure provides a defect detection device that precisely controls the characteristics of various types and numbers of the defects to generate high-quality defect images, thereby significantly improving the performance of the automatic defect classification and enhancing the semiconductor yield.

According to some implementations of the present disclosure, a defect detection device includes a memory; and a processor, wherein the processor includes a feature extractor that generates a feature vector by using an information about a defect as an input value; a feature splitter that generates a mask defining the defect by using the feature vector as an input value; and an image generating unit for generating a normal image and an image including a semiconductor defect from the mask.

According to some implementations of the present disclosure, a defect detection device includes a memory; and a processor, wherein the processor includes a feature extractor that generates a feature vector by taking a feature of a design information as an input value; a feature modifier that generates a second design information by modifying a first design information, which is a design image for a wafer in a semiconductor manufacturing process, based on the feature vector; and an image generator for generating an image including a semiconductor defect based on the second design information.

According to some implementations of the present disclosure, a defect detection device includes a memory; and a processor, wherein the processor includes a feature extractor that extracts a first feature vector using an information about a defect as an input value and a second feature vector using a feature about a design information as an input value; a feature splitter that outputs a mask defining the defect by using the first feature vector as an input value; a feature modifier including a first image encoder for extracting a feature vector as an input value from a first design information, which is a design image for a wafer in a semiconductor manufacturing process, a first conditional insertion unit for combining the second feature vector with the feature vector for the first design information, and a first image decoder for generating a second design information based on the combined vector information; and an image generator including a second image encoder that takes a normal image and a second design information as an input value to output a feature vector, a second conditional insertion unit that combines an information about a mask generated from the feature splitter and the feature vector generated from the second image encoder, and a second image decoder that generates a defective image based on the combined vector information.

In some implementations of the present disclosure, a defect detection method may include performing a language model by inputting a defect prompt, extracting a feature vector value, performing a split model by inputting the feature vector value, outputting a mask defining a defect, performing a generation model by inputting the mask, and extracting a semiconductor defect image.

In some implementations of the present disclosure, a defect detection method may include performing a language model by inputting a design prompt, extracting a feature vector value, performing a correction model by inputting the feature vector value and a first design information, extracting a second design information, performing a generation model by inputting the second design information, and extracting a semiconductor defect image.

In some implementations of the present disclosure, a defect detection method may include performing a language model by inputting a defect and a design prompt, respectively, extracting a first feature vector value and a second feature vector value, performing a split model by inputting the first feature vector value, performing a modification model by inputting the second feature vector value and the first design information, extracting a mask and a second design information, performing a generation model by inputting the mask, the second design information, and a normal image, and extracting a semiconductor defect image.

According to some implementations of the present disclosure, the defect detection device includes the feature split unit that outputs the mask defining the defect using the feature vector, thereby generating various types of the defect images based on a small amount of the defect images, thereby reducing a repetitive measurement task.

According to some implementations of the present disclosure, the defect detection device includes the feature modification unit that outputs the second design information by using the first design information and the feature vector, and generates the semiconductor defect image by using the second design information modified by the feature modification unit, thereby providing faster results compared to conventional defect detection methods, thereby reducing a time and a cost.

According to some implementations of the present disclosure, the defect detection device outputs the semiconductor defect image by taking at least one of the design information, the mask, and the normal image as the input value, thereby precisely controlling the characteristics of various types and numbers of the defects to generate the high-quality defect image, thereby greatly improving the performance of an automatic defect classification and enhancing a semiconductor yield.

According to some implementations of the present disclosure, the defect detection method includes outputting the semiconductor defect image by using at least one of the design information, the mask, and the semiconductor normal image, thereby precisely controlling characteristics of various types and numbers of the defects to generate the high-quality defect image, thereby greatly improving the performance of an automatic defect classification and enhancing a semiconductor yield.

### BRIEF DESCRIPTION OF THE DRAWINGS

FIG. 1 is a block diagram of a defect detection device according to some implementations of the present disclosure.

FIGS. 2, 3 and FIG. 4 are block diagrams of a processor of a defect detection device according to various implementations of the present disclosure.

FIG. 5 and FIG. 6 are block diagrams of a defect detection device according to various implementations of the present disclosure.

FIG. 7 is a block diagram showing a driving sequence of a defect detection device according to some implementations of the present disclosure.

FIGS. 8A, 8B, 9A, 9B, 10A and FIG. 10B are schematic diagrams of a defect detection device according to various implementations of the present disclosure.

FIG. 11 and FIG. 12 are block diagrams of a defect detection device according to various implementations of the present disclosure.

FIG. 13 is a flowchart of a defect detection method according to some implementations of the present disclosure.

FIG. 14 and FIG. 15 are detailed flowcharts of a defect detection method of FIG. 13.

FIG. 16 is a flowchart of a defect detection method according to some implementations of the present disclosure.

FIG. 17 is a detailed flowchart of a defect detection method of FIG. 16.

FIG. 18 is a flowchart of a defect detection method according to some implementations of the present disclosure.

FIG. 19 is a detailed flowchart of a defect detection method of FIG. 18.

### DETAILED DESCRIPTION

The present disclosure will be described more fully hereinafter with reference to the accompanying drawings, in which implementations of the present disclosure are shown. As those skilled in the art would realize, the described implementations may be modified in various different ways, without departing from the spirit or scope of the present disclosure.

Descriptions of parts not related to the present disclosure are omitted, and like reference numerals designate like elements throughout the specification.

Further, since sizes and thicknesses of constituent members shown in the accompanying drawings are arbitrarily given for better understanding and ease of description, the present disclosure is not limited to the illustrated sizes and thicknesses. In the drawings, the thickness of layers, films, panels, regions, etc., are exaggerated for clarity. In the drawings, for better understanding and ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. In addition, the word “on” means positioning on or below the object portion, but does not necessarily mean positioning on the upper side of the object portion based on a direction of gravity.

In addition, unless explicitly described to the contrary, the word “comprise”, and variations such as “comprises” or “comprising”, will be understood to imply the inclusion of stated elements but not the exclusion of any other elements.

Additionally, terms such as “. . . part”, “. . . device”, “. . . module”, etc. described in the specification perform at least one function or operation, and may be implemented by hardware or software, or by a combination of hardware and software. Additionally, a plurality of “. . . parts”, a plurality of “. . . units”, or a plurality of “. . . modules” may be integrated into at least one module and implemented with at least one processor, except for a “. . . part”, a “. . . unit”, or a “. . . module” that needs to be implemented with specific hardware.

In this specification, “transmitting” or “providing” may include not only directly transmitting or providing, but also indirectly transmitting or providing via another device or by using a bypass route.

In this specification, expressions described in the singular may be interpreted as singular or plural, unless explicit expressions such as “one” or “singular” are used.

Hereinafter, implementations of the present disclosure will be described in detail so that a person having ordinary knowledge in the technical field to which the present disclosure belongs can easily implement the present disclosure. However, the present disclosure may be implemented in many different forms and is not limited to the implementations described herein.

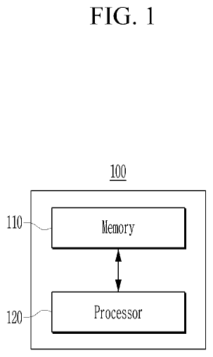

FIG. 1 is a block diagram of a defect detection device 100 according to some implementations of the present disclosure.

Referring to FIG. 1, a defect detection device 100 according to some implementations of the present disclosure can generate an optical image including a defect occurring in a semiconductor manufacturing process based on an artificial neural network or an algorithm for an automatic classification of semiconductor defects. The defect detection device 100 of the present disclosure may secure a relatively insufficient defect data by controlling semiconductor defect characteristics, thereby improving the performance and reliability of the semiconductor automatic defect classification model.

The defect detection device 100 may detect defects created on a wafer during a semiconductor manufacturing process. The semiconductor manufacturing process may identify the defects in the wafer during various semiconductor manufacturing processes, such as a chemical mechanical polishing process, a photoresist application process, an exposure process, a development process, an etching process, a deposition process, or a cleaning process. Specifically, as various defects in the circuit pattern of the wafer in the semiconductor manufacturing process may be generated depending on the type, shape, size, or location, the defect detection device 100 may precisely control these characteristics to generate the image including the similar level of the defects.

In some implementations, the defect detection device 100 includes a memory 110 and a processor 120. Specifically, the defect detection device 100 may be driven by a processor 120 by data or program instructions stored in the memory 110. More specifically, the defect detection device of the present disclosure may generate a high-quality image including the various defects by a language model, a modification model, and a generation model stored in the memory 110.

The memory 110 may be a storage device for storing the data or program instructions to be processed by the processor 120. Specifically, the memory 110 may store software such as a learned neural network model, an image processing algorithm, or a defect detection ruleset. More specifically, the software stored in the memory 110 may assist the processor 120 to process the data.

The memory 110 may include any temporary computer-readable medium known to those skilled in the art, including, for example, a volatile memory such as a static random-access memory (SRAM) and a dynamic random-access memory (DRAM), and/or a nonvolatile memory such as a read-only memory (ROM), an erasable programmable ROM, a flash memory, hard disks, optical disks, and a magnetic tape.

The processor 120 may be configured to retrieve and execute a data stored in the memory 110. Specifically, the processor 120 may perform an image processing function using data or instructions stored in the memory 110. More specifically, the processor 120 may control the defect detection device 100 to create a high-quality defect image according to the data stored in the memory 110 and a software such as a learned neural network model, an image processing algorithm, or a defect detection rule set.

The processor 120 may be a single processing unit or multiple units, all of which may include multiple computing units. For example, the processor 120 may be implemented as one or more microprocessors, microcomputers, microcontrollers, digital signal processors, central processing units, state machines, logic circuits, and/or any device that manipulates signals based on operational instructions.

The processor 120 may include one or more processors. At this time, one or more processors may be a general-purpose processor such as a central processing unit (CPU), an application processor, a graphics-only processing unit such as a graphics processing unit (GPU), or a visual processing unit (VPU), and/or an AI-only processor such as a neural processing unit (NPU). One or more processors may control the processing of the input data according to predefined operating rules or artificial intelligence (AI) models stored in the non-volatile memory and the volatile memory. Specifically, the processor 120 may operate based on predefined operating rules or a machine learning model trained through a learning, and such operating rules or models may be provided from the memory 110.

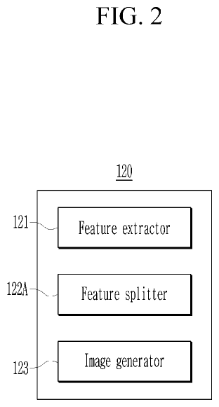

FIG. 2 to FIG. 4 are block diagrams of a processor 120 of a defect detection device 100 according to various implementations of the present disclosure.

Referring to FIG. 2, in some implementations, the processor 120 may include a feature extractor 121, a feature splitter 122A, and an image generator 123. Specifically, the processor 120 may be executed by each of a plurality of models stored in the memory 110, split a mask defining a defect from a language-based model, and generate an image including the split mask to generate a high-quality image including various types of defects.

The feature extractor 121 may extract a feature vector by using an information about the defect as an input value. Specifically, the feature extractor 121 may input an information about the defect as a prompt and perform the language-based model therefore to generate the feature vector as an embedding vector.

The information about the defect may be the information such as the type, location or shape of the defect. Specifically, the information about the defect may include various information related to the defect, such as the type, location, size, and number of the defect. The feature extractor 121 may input a natural language-based prompt including the information about the defect.

In some implementations, the feature extractor 121 may be performed by a language model. Specifically, the feature extractor 121 may generate the feature vector based on a text prompt. More specifically, the language model may receive the text prompt including the information about the defect as an input value, and input the prompt into the natural language processing model to generate an embedding vector.

In some implementations, the natural language processing model may be a Transformer-based language model that generates context-based embeddings. Specifically, the natural language processing model may be a language model performed with a structure of an autoregressive method or a mask-based prediction method. For example, the natural language processing model may utilize various types of language models such as a GPT with a transformer and an autoregressive structure, a BERT based on a transformer and a masking, a T5 with an encoder and decoder structure and a masking structure, a PaLM based on a transformer, an OPT with a GPT autoregressive structure, or an LLaMA, as non-limiting examples.

The feature splitter 122A may generate a mask. Specifically, the feature splitter 122A may generate the mask by using the feature vector generated by the feature extractor 121 as an input value. More specifically, the feature splitter 122A may extract the information about the defect as an image based on the feature vector.

The mask may define the defect by spatially specifying the area including the defect. Specifically, the image for the defect may be generated by selectively highlighting or extracting the pixel locations that meet the conditions based on the embedding vector that includes the meaning of the natural language prompt. In this way, the mask spatially designates the area including the defect, and in particular, may mean the image obtained by separating or dividing the defective portion along the boundary of the defect.

In some implementations, the feature splitter 122A may include a split model. Specifically, the split model may be a conditional image split model. More specifically, the conditional image split model may spatially reinterpret the meaning indicated by the defect-related embedding vector received from the feature extractor 110 and generate the mask reflecting the visual location information of the defect.

The feature splitter 122A can be performed with various types of conditional image split models, such as, for example, a U-Net-based split decoder, a mask R-CNN-based structure, a split anything model (SAM)-based decoder, or a CLIP SegFormer-based structure.

In some implementations, the feature splitter 122A may include a multi-stage split structure that gradually refines and outputs the mask defining the defect based on the feature vector generated by the feature extractor 121. For example, the multi-stage split structure may first generate a candidate region, and secondarily precisely adjust the boundary and generate the mask. Accordingly, the precision of the mask can be improved.

In this way, the processor 120 may generate the mask for the defect as the image based on the text condition by including the feature splitter 122A, and automatically generate the mask reflecting the common defect in thousands of images with just one prompt, thereby having an advantage in the automatic expansion of the artificial intelligence learning data.

The image generator 123 may generate a normal image and the image including the semiconductor defect from the mask. Specifically, the image generator 123 may generate a final defect image including the semiconductor defect by using the separately supplied normal image and the mask transmitted from the feature splitter 122A.

The normal image may be an image of the wafer that does not include any defects. For example, the normal image means an image without the defects of the wafer or the semiconductor chip that is a target of the detection in the semiconductor process in which the defect detection device is intended to detect the defect. Specifically, the normal image includes not only an image completely free of the defects, but also an image that may be judged as a normal at the process stage even if it includes some degree of the defects.

The image generator 123 may encode the normal image as an input value and insert or fuse the feature vector for the mask as a condition into the encoded feature vector. Next, the final defect image may be generated based on the feature vector reflecting the condition.

The image generator 123 may include a generation model. Specifically, the generative model may include various types of models, such as, for example, a generative adversarial network (GAN)-based generator, a ciffusion model-based generator, and an auto encoder-based generator.

In some implementations, the image generator 123 may generate the adjusted image by fusing multiple vector information. Specifically, the image generator 123 may further fuse the feature vector including the information on the defect generated from the feature extractor 121.

For example, the image generator 123 may fuse the feature vectors generated by the prompt that include the information about the defect as well as the vector information about the normal image and the vector information about the mask. In this way, after fusing the multiple vectors and then generating the image that includes the defects, an image that includes more sophisticated and diverse defect characteristics may be generated.

In this way, the defect detection device 100 generates the image including the defect in the image generator 123 after passing through the feature splitter 122A, thereby generating the image including various similar defects thereto based on the information about the defect having the excessively little information, thereby reducing the repetitive measurement work and efficiently obtaining the high-quality defect images. Through this, the performance of the automatic classification function may be significantly improved and the semiconductor yield may be improved by precisely controlling the characteristics of the various types and numbers of the defects.

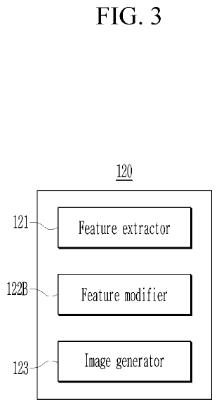

Referring to FIG. 3, in some implementations, the processor 120 includes a feature extractor 121, a feature modifier 122B, and an image generator 123. Specifically, the processor 120 may be respectively executed by the plurality of models stored in the memory 110, and generate the modified design information by fusing the feature vectors for the design information from the language-based model in the feature modifier 122B, and may generate the high-quality images including the various types of the defects based thereon.

The feature extractor 121 may extract the feature vector by using the features of the design information as input values. Specifically, the feature extractor 121 may input the feature regarding the design information as the prompt and perform the language model thereon to generate the feature vector as an embedding vector.

The features of the design information may be various information about the type of the design pattern or about the modification characteristics. The feature extractor 121 may input the natural language-based prompt including the features for the design information.

In some implementations, the feature extractor 121 may be performed by the language model. Specifically, the feature extractor 121 may generate the feature vector based on the text prompt. More specifically, the language model may receive the text prompt including the features about the design information as an input value, and input the prompt into the natural language processing model to generate the embedding vector. The natural language processing model may be a language model that generates context-based embeddings, for example, a transformer-based language model.

The feature modifier 122B may modify the first design information to generate the second design information. Specifically, the first design information may be a design image for the wafer in a semiconductor manufacturing process. For example, the design image may be a normal design image.

The normal design image may be an image for a wafer that does not include any defects in the design information. For example, the normal design image means an image without the defects among the design images of the semiconductor process for which the defect is to be detected by the defect detection device. Specifically, the normal design image includes not only the image completely free of the defects, but also an image that may be judged as a normal at the process stage even if it includes some degree of the defects.

The feature modifier 122B may combine the feature vector for the first design information and the feature vector generated from the feature extractor 121. Specifically, the feature modifier 122B may generate the feature vector for the normal design image, which is the first design information, and combine the feature vector generated by the feature extractor 121 with the feature vector.

The feature modifier 122B may modify the feature vector of the first design information based on the feature vector generated by the feature extractor 121 to generate the modified second design information. The second design information may be the design image modified based on the design embedding vector in the normal design image. The second design information may also include an area that deviates from the pattern type and the modification characteristics for the design information input as a prompt to the feature extractor 121. The deviated area may be defined as the defect, which allow us to identify a subtle defect difference between the planned design information and the actual measured image.

In some implementations, the feature modifier 122B may include a modification model. Specifically, the modification model may utilize various models capable of merging the feature vector generated from the feature extractor 121 and the feature vector for the first design information. For example, the modification model may be performed by various structures such as a conditional autoencoder, a U-Net structure, a GAN-based structure, a diffusion-based structure, and an MLP-based feature modifier structure.

In this way, the defect detection device 100 may automatically correct the design structure or generate the image reflecting the defect condition through the feature vector generated from the feature extractor 121 using the language model and the feature vector for the first design information. Additionally, since it is possible to generate various design change samples with one prompt, it may also be used as an AI learning data.

The image generator 123 may generate the image including the semiconductor defect based on the second design information. Specifically, the image generator 123 may generate the image including the defect by using the second design information generated from the feature modifier 122B as an input value and using the generation model.

In some implementations, the image generator 123 may include the generation model. Specifically, the generative model may include various types of models, such as, for example, a generative adversarial network (GAN)-based generator, a diffusion model-based generator, and an autoencoder-based generator.

In some implementations, the image generator 123 may generate the adjusted image by fusing the plurality of vector information. Specifically, the image generator 123 may further fuse the feature vector including the features for the design information generated from the feature extractor 121.

For example, the image generator 123 may fuse the vector information on the second design information and the feature vector generated by the prompt including the feature on the design information. In this way, by fusing the multiple vectors of the design information and then generating the image including the defect, the image including more sophisticated and diverse defect characteristics may be generated.

In this way, the defect detection device 100 may identify and control the various defects included in the actually measured design image by using the first design information as a source to generate the image including the defect, thereby generating the image including the high-quality defect and greatly improving the performance of the automatic defect classification, thereby improving the semiconductor yield.

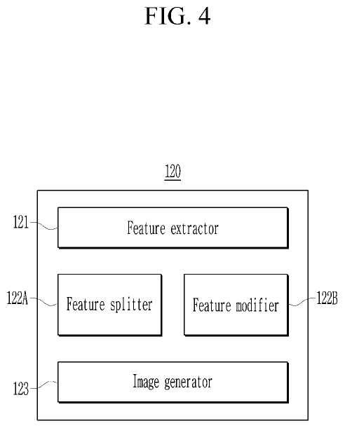

Referring to FIG. 4, in some implementations, the processor 120 includes a feature extractor 121, a feature splitter 122A, a feature modifier 122B, and an image generator 123. Specifically, the processor 120 may improve the quality of the image including the generated defect by simultaneously including the feature splitter 122A and the feature modifier 122B. The detailed information about the feature extractor 121, the feature splitter 122A, the feature modifier 122B, and the image generator 123 may be referenced to the contents described above in FIG. 1 to FIG. 3 to the extent that they do not contradict each other.

The feature extractor 121 may extract the feature vector by using the information about the defect and the design information as an input value. Specifically, the feature extractor 121 may generate and classify the features on the information about the defect and the design information as an input value into a separate feature vector, respectively. The feature vector generated by inputting the information about the defect as a prompt may be a first feature vector, and the feature vector generated by inputting the feature about the design information as a prompt may be a second feature vector.

The feature splitter 122A may generate a mask that defines the defect based on the first feature vector obtained from the feature extractor 121. Specifically, the feature splitter 122A may extract the mask defining the defect as an image by spatially specifying an area including the defect based on the first feature vector. More specifically, the feature splitter 122A may spatially reinterpret the meaning indicated by the first feature vector by using a split model and generate the mask reflecting the visual location information of the defect.

The feature modifier 122B may generate a second design information by combining the second feature vector obtained from the feature extractor 121. Specifically, the feature modifier 122B can generate second design information by combining the second feature vector with the feature vector of the first design information. More specifically, the feature modifier 122B may fuse the second feature vector and the feature vector for the first design information by using a modification model.

The image generator 123 may generate the normal image and the image including the semiconductor defect from the mask, and may generate the image including the semiconductor defect based on the second design information. Specifically, the image generator 123 may generate the final defect image including the semiconductor defect by using the separately supplied normal image and the mask transmitted from the feature splitter 122A, and may also generate the final defect image including the semiconductor defect by using the second design information generated from the feature modifier 122B as an input value.

The image generator 123 may include a generation model. Specifically, the generation model may generate the final defect image including the semiconductor defect using one model or the plurality of models. For example, if the generation model is one model, the final defect image including the semiconductor defect may be generated by using the normal image and the mask transmitted from the feature splitter 122A, and then the final defect image including the semiconductor defect may be generated by using the second design information generated from the feature modifier 122B as an input value. As a non-limiting example, after generating the final defect image from the second design information, the final defect image may be generated using the mask. At this time, the final defect image may be the similar defect images to each other.

As above described, the defect detection device 100 includes the feature splitter 122A and the feature modifier 122B within the processor 120, the various similar defect images with only the small amount of the defect images may be generated, thereby reducing the repetitive measurement work, and the high-quality defect images may be generated by precisely reflecting the characteristics of the defect, thereby improving the semiconductor yield.

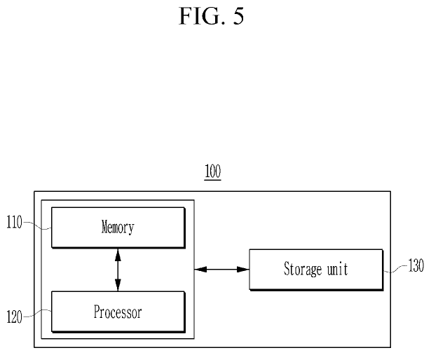

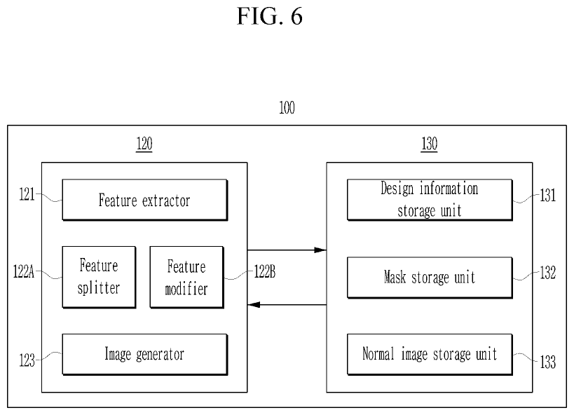

FIG. 5 and FIG. 6 are block diagrams of a defect detection device according to various implementations of the present disclosure.

Referring to FIG. 5 and FIG. 6, in some implementations, the defect detection device 100 may include a storage unit 130. The storage unit 130 may store semiconductor images. The semiconductor image may be an image including a defect, such as design information, a mask, or a normal image, for example.

The design information may be a normal design image for a wafer in the semiconductor manufacturing process, and may be a design image for a wafer that does not include any defects. The mask may be an image that defines the defect by spatially specifying the area including the defect. The normal image may be an image of a wafer that does not include any defects.

In some implementations, the storage unit 130 may include a design information storage unit 131, a mask generator 132, and a normal image storage unit 133. The design information storage unit 131 may store the first design information provided to the feature modifier 122B. Specifically, the design information storage unit 131 may provide the first design information so that the feature vector generated from the feature extractor 121 may generate the second design information in the feature modifier 122B.

In some implementations, the design information storage unit 131 may also store the second design information generated by the feature modifier 122B. Specifically, the second design information may be an image that includes the defect, unlike the first design information, which is the normal image without a defect, in which the normal image is modified by the vector information output by inputting the feature of the design information as a prompt.

The design information storage unit 131 may construct a modified design data set according to various defect conditions by storing not only the first design information but also the second design information. Specifically, a defect generation model may be trained based on the difference data between the first design information and the second design information.

In some implementations, the design information storage unit 131 supplies the stored second design information to the feature extractor 121, so that when the prompt for the feature for the design information is input, not only a text but also an image is additionally provided, so that the feature vector for the more accurate feature of the design information may be generated.

The mask storage unit 132 may separately store the image including the defect. The image including the defect may be a mask produced by defining a boundary of the specific area where the defect is formed. The mask may be a separate image supplied from the outside, or may be a mask provided from the feature splitter 122A.

Specifically, the mask storage unit 132 supplies the mask produced and provided from the feature splitter 122A to the feature extractor 121, so that when the prompt for the defect information is input, not only the text but also the image may be additionally provided to generate the feature vector for more accurate defect information.

The normal image storage unit 133 may supply the normal image without the defect to the image generator 123. Specifically, the normal image storage unit 133 may supply the normal image provided from the outside to the image generator 123 to assist in combining the vector for the mask provided from the feature splitter 122A with the vector for the normal image.

The design information storage unit 131, the mask storage unit 132, and the normal image storage unit 133 may be implemented in various ways, such as, for example, a storage that stores simple image files such as JPG, PNG, and TIFF, a metadata database including a mapping information between the images and the conditions such as a JSON and an XML, a data storage format based on a deep learning framework such as TFRecord, HDF5, and LMDB, or a conditional searchable index system through a hash-based sorting by a design information.

In some implementations, the feature extractor 121 may include a multi-modal model. Specifically, the feature extractor 121 may generate a multimodal embedding vector by combining at least one of the prompt including the information about the defect and the semiconductor image. Specifically, the feature extractor 121 may include a multimodal model by combining the prompt with the separate design information or the mask provided from the storage unit 130.

For example, the multimodal model may include models such as CLIP, Flamingo, and BLIP. The mask or the second design information including more sophisticated and diverse defects may be generated by combining the text and the images in the feature splitter 122A or the feature modifier 122B.

In some implementations, the multimodal model may generate an attention map based on the prompt, and generate a location of a defect candidate region as a feature vector based on the attention map. Specifically, the location of the defect may be predicted in the multimodal model and a map may be generated based on the prediction.

In some implementations, the feature extractor 121 may generate the feature vector with the adjusted sensitivity of the defect by adjusting a weight or moving a direction within the embedding space according to the defect condition or the design condition included in the prompt. In this way, the feature extractor 121 may adjust the embedding according to the condition of the prompt.

Each of the models described above in FIG. 1 to FIG. 6 may be configured with various forms of artificial neural networks or algorithms and performed by the processor 120. The artificial neural network may be implemented in a manner that includes, for example, at least one of a single layer perceptron, a multilayer perceptron (MLP), a convolutional neural network (CNN), and a transformer-based neural network as an artificial neural network structure based on deep learning. The algorithm may be implemented in a manner that includes, for example, at least one of an edge detection based filtering algorithm, a threshold based fault masking algorithm, or a statistical based fault detection and histogram analysis technique.

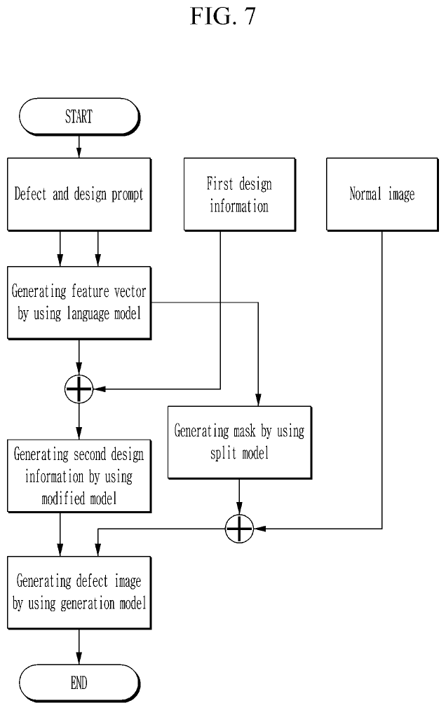

FIG. 7 is a block diagram showing a driving sequence of a defect detection device 100 according to some implementations of the present disclosure.

Referring to FIG. 7, a defect prompt, which is a prompt for an information about a defect, is supplied to a language model, and a design prompt, which is a prompt for a feature of a design information, is also supplied separately to the language model so that a separate feature vector may be respectively generated.

Thereafter, the feature vector generated by the defect prompt may be combined or fused with the feature vector for the first design information, and the second design information may be generated using the modified model. In contrast, the feature vector generated from the design prompt may be used to generate a mask using a split model.

Thereafter, the second design information may be used to generate the defect image including the defect by using a generation model. The mask may be combined or fused with a vector for a separately supplied normal image to generate a defective image including the defect. At this time, the combined images may not be identical to each other. Through this, multiple images including various types of defects may be generated.

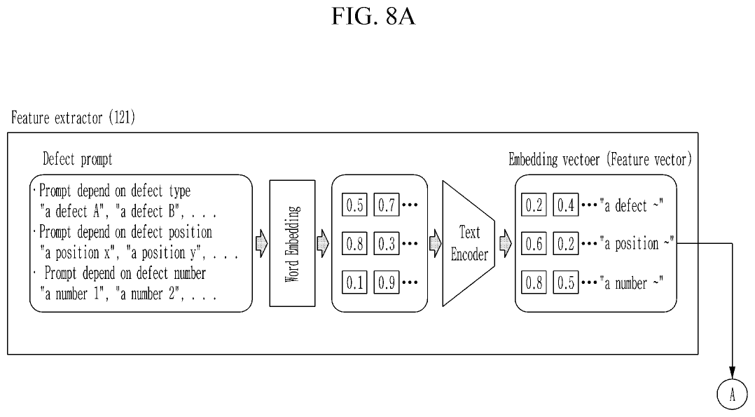

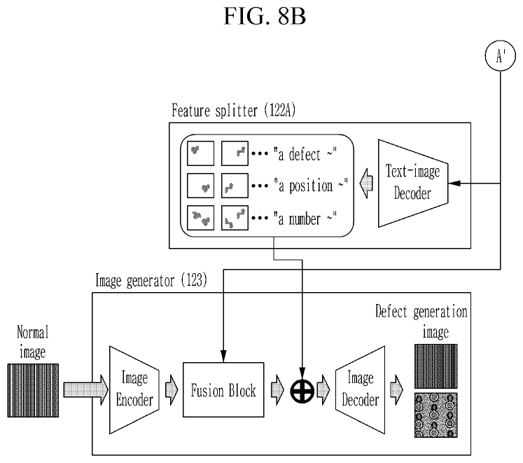

FIGS. 8A to 10B are schematic diagrams of a defect detection device 100 according to various implementations of the present disclosure.

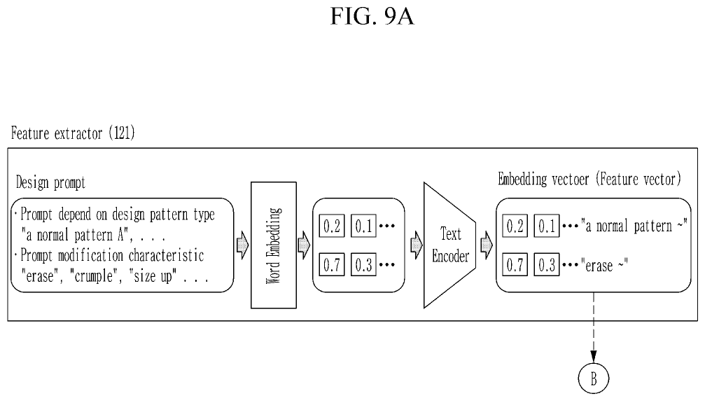

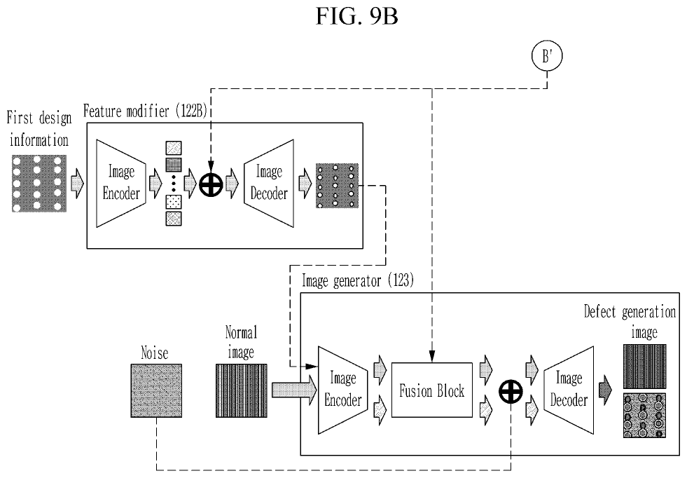

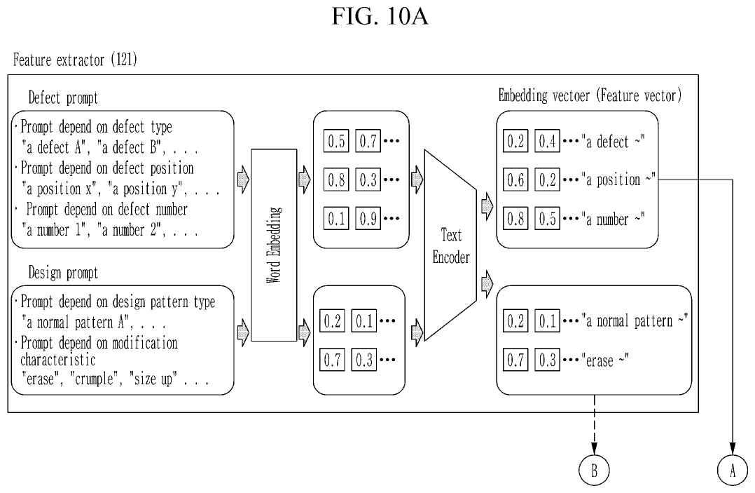

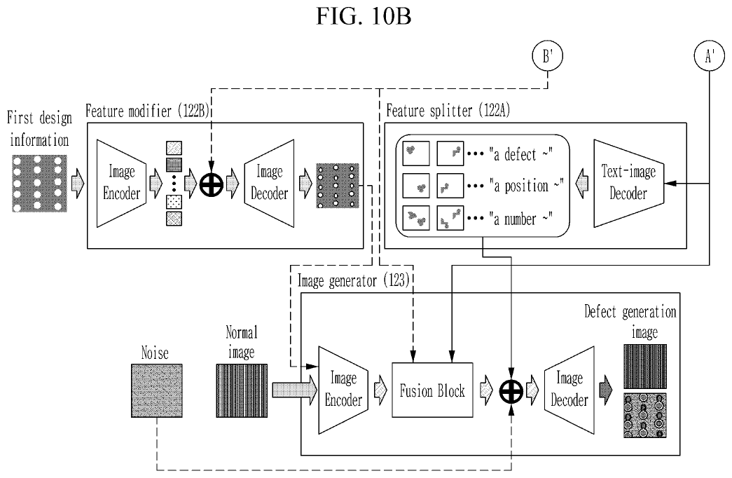

FIG. 8A and FIG, 8B are the schematic diagrams of the defect detection device 100 corresponding to FIG. 2, FIG. 9A and FIG, 9B are the schematic diagrams of the defect detection device 100 corresponding to FIG. 3, and FIG. 10A and FIG, 10B are the schematic diagrams of the defect detection device 100 corresponding to FIG. 4.

Referring to FIG. 8A and FIG, 8B, the defect detection device 100 may sequentially perform the feature extractor 121, the feature splitter 122A, and the image generator 123 to generate the defect generation image. The feature extractor 121 may generate the feature vector, which is an embedding vector, by inputting the defect prompt and performing the language model.

The feature extractor 121 may include a word embedding and a text encoder. Specifically, the word embedding unit receive the prompt including the information about the defect to generate an embedding vector. For example, the word embedding may divide the prompt input as a natural language sentence into a word unit and then perform an embedding process of mapping each word to a vector of a fixed length. The embedding process may be a pre-trained method such asGloVe, Word2Vec, BERT-Tokenizer, CLIP tokenizer, but not limited thereto.

The text encoder may classify the feature vector for the defect based on the embedding vector generated from the word embedding. Specifically, the text encoder may be configured to receive a word embedding vector sequence output from the word embedding as an input and to output an integrated embedding vector reflecting a contextual meaning. The text encoder may be implemented as a transformer-based encoder network and may be performed by a language model. The language model may be performed by various language models such as, for example, GPT, BERT, CLIP-TextEncoder, but is not limited thereto.

In some implementations, the feature splitter 122A may include a text-image decoder. Specifically, the text image decoder may output the image defining the defect based on the feature vector provided from the feature extractor 121.

The text image decoder may split the defective area by using the text embedding as a condition and generate the mask. The text image decoder may include a split model including at least one of a condition-based split network structure such as, for example, U-Net, DeepLab, Mask R-CNN, SegFormer, or SAM (Split Anything Model), and the split model is not limited to the above-described examples.

The text image decoder may include a split model. Specifically, the text image decoder may input a defect-related embedding vector generated from the feature extractor 121 and generate the mask reflecting a visual location information of the defect.

In some implementations, the split model may be a conditional image split model. For example, the conditional image split model may include various kinds of split models, such as a U-Net based split decoder, a Mask R-CNN based structure, a Split Anything model (SAM) based decoder, or a CLIP SegFormer based structure.

The U-Net-based split decoder may generate a mask by inserting a text condition into the intermediate layer or reflecting the embedding vector as a normalization condition of the decoder path. The Mask R-CNN-based structure may be a method of selectively emphasizing and outputting an area that meets a text condition among a plurality of mask candidates.

The split anything model (SAM)-based decoder refine and output a mask that satisfies the condition from a preprocessed mask feature pool by using an input condition vector. The above CLIP SegFormer-based structure may fuse a text embedding and an image feature with a transformer to generate a mask after a semantic alignment.

In some implementations, the feature splitter 122A may include a multi-stage split structure that gradually refines and outputs a mask defining a defect based on a feature vector generated by the feature extractor 121. For example, the multi-stage split structure may be a split structure such as a coarse-to-fine stage based on the feature vector. The coarse-to-fine step may be performed by generating a candidate region in a step 1, fine-tuning the boundary in a step 2, and then splitting the mask to generate the candidate region.

In some implementations, the image generator 123 may include an image encoder and an image decoder. Specifically, the image generator 123 may encode the normal image in the image encoder to extract the feature vector, and decode the feature vector into a high-resolution image in the image decoder.

The image encoder may extract a spatial, structural, or morphological feature of the input normal image as a feature vector. Specifically, the image encoder may provide a compressed expression space so that the normal image may be used for inserting a condition in a subsequent configuration or as a condition for generating an image. Through this, high-dimensional image data may be compressed into an embedding format to reflect a multi-layered meaning, and the fusion between a spatial information and a conditional information may be facilitated.

In some implementations, the image encoder may utilize various methods, such as an encoder configuration of a convolutional neural network (CNN), a vision transformer (ViT), an autoencoder, or an image encoder module of SAM or CLIP. However, the above-mentioned examples do not limit the image encoder.

The image decoder may restore or generate the feature vector extracted from the image encoder back into an image form based thereon. Specifically, the image decoder may generate the image including the defect by decoding a plurality of feature vectors that combine the feature vector extracted from the image encoder and the feature vector for the mask received from the feature splitter 122.

In some implementations, the image decoder section may utilize various methods, such as, for example, a U-Net decoder path, a generator decoder path of a GAN, a decoder structure of an autoencoder, or an image generation path of a diffusion model. However, the above-mentioned examples do not limit the image decoder.

In some implementations, the image generator 123 may include a conditional insertion unit (also referred to as “a conditional insertion circuit”). The conditional insertion unit may combine the feature vector of the normal image and the feature vector for the mask generated by the feature splitter 122A. Specifically, the conditional insertion unit may generate the integrated feature vector reflecting the defect generation condition by mutually fusing the above-described plurality of feature vectors.

For example, the conditional insertion unit may combine multiple feature vectors in a spatial or channel-wise fusion manner, and adjust the input feature so that the subsequent image decoder may change the image output according to the conditional information. The conditional insertion unit may utilize, as a non-limiting example, a simple concatenation method that merges two vectors based on a channel or a position, such as a GAN or an MLP, an adaptive instance normalization (AdaIN) method that applies a normalization parameter as a text condition to an image feature, such as a style GAN or an U-Net, a spatially adaptive denormalization (SPADE) method that reflects a condition by inserting a condition in a form of a spatial mask, such as a semantic-to-image, a cross-attention insertion method that performs an attention operation on a text vector as queries, keys, and values, such as a diffusion and a CLIP ViT, and a method that combines two vectors in a FC layer and then reconstructs an image feature, such as a transformer series or a latent fusion. However, the above-described method does not limit the above-described conditional insertion unit.

In some implementations, the image generator 123 may include a fusion block. The fusion block is positioned between the image encoder and the image decoder, and may combine the feature vector generated from the feature extractor 121 with the feature vector extracted from the image encoder. Specifically, the fusion block may combine a defect prompt-based feature vector provided from the feature extractor 121 with the feature vector for the normal image. The fusion block may modify the feature vector for the normal image by combining the feature vector for the defect with the normal image as a condition.

In some implementations, the fusion block may be placed before the conditional insertion unit. Specifically, the fusion block may be placed between the image encoder and the condition insertion. Since the fusion block is placed between the image encoder and the condition insertion, the feature vector for the normal image may be adjusted by the feature vector extracted from the feature extraction part 121, and then the feature vector for the mask may be combined in the conditional insertion unit, so that a more sophisticated final image may be generated.

Specifically, the conditional insertion unit may additionally combine a vector information about the mask provided from the feature splitter 122A to the feature vector for the normal image, thereby assisting in spatially reflecting how and at what location the corresponding defect will be specifically inserted.

In this way, the fusion block may be configured to generate the high-quality defect image in which the corresponding defect condition is spatially reflected by adjusting the feature vector for the normal image by the defect condition vector according to the prompt and combining the mask for the adjusted feature.

Referring to FIG. 9A and FIG, 9B, the defect detection device 100 may sequentially perform a feature extractor 121, a feature modifier 122B, and an image generator 123 to generate a defect generation image. The feature extractor 121 may generate the feature vector, which is an embedding vector, by inputting a design prompt and performing a language model.

The feature extractor 121 may include a word embedding and a text encoder. Specifically, the word embedding may receive the prompt including the feature regarding the design information and generate the embedding vector.

The text encoder classify the feature vector for the design information based on the embedding vector generated from the word embedding. Specifically, the text encoder may be configured to receive a word embedding vector sequence output from the word embedding as an input and to output an integrated embedding vector reflecting a contextual meaning. For further details, the reference may be made to the content described above in the feature extraction section 121 of FIG. 8, to the extent that it does not contradict the content.

The feature modifier 122B may generate a second design information including the design information modified based on the first design information for the design image. Specifically, the feature modifier 122B may encode the first design information and combine the feature vector received from the feature extractor 121 with the feature vector for the first design information, and then generate a modified second design information.

Specifically, the feature modifier 122B may include a first image encoder, a first conditional insertion unit, and a first image decoder. The first image encoder may extract the feature vector by using the first design information as an input value. Specifically, the first image encoder may extract the spatial, structural, or morphological feature for the first design information, which is an image, as a feature vector. Specifically, the first image encoder may provide a compressed expression space so that the first design information may be utilized as a condition for inserting a condition in a subsequent configuration or as a condition for generating an image.

In some implementations, the first image encoder may utilize various methods, such as an encoder configuration of a convolutional neural network (CNN), a vision transformer (ViT), an autoencoder, or an image encoder module of a SAM or a CLIP. However, the above-mentioned example does not limit the first image encoder.

The first conditional insertion unit may combine the feature vector generated from the feature extractor 121 with the feature vector for the first design information. Specifically, the first conditional insertion unit may generate the feature vector to include the defect defined as the area that deviates from the pattern type and the modification characteristic for the design information input as a prompt to the feature extractor 121 in the first design information by mutually fusing the feature vector of the first design information and the feature vector generated by the feature extractor 121.

For example, the feature extractor 121 inputs a natural language text including the defect or change condition and generates the feature vector through an embedding structure based on a language model, and accordingly, the design meaning may be converted into a quantified vector information and provided to the first conditional insertion unit. The feature vector provided from the feature extractor 121 may be fused with the vector for the first design information to generate the feature vector that reflects conditions including the user's design intention or the defect information, not just visual features on the image.

In this way, the first conditional insertion unit may generate the second design information generated from the first image decoder that may clearly and structurally respond to the minute defects that are difficult to distinguish with only the first design information, or an abstract defect condition defined as a text without a fixed condition, by modifying the feature vector for the first design information with the feature vector of the feature extractor 121 according to the condition. Therefore, the fault detection device 100 may significantly improve the simulation, control, generation, and detection performances for the various defect scenarios.

The first image decoder may generate the second design information based on the feature vector combined in the first conditional insertion unit. Specifically, the image decoder may restore or generate the combined feature vector that has passed through the first conditional insertion unit back into an image form based thereon.

The first image decoder may utilize various methods, such as, for example, a U-Net decoder path, a GAN generator decoder path, an autoencoder decoder structure, or an image generation path of a diffusion model. However, the above-described example does not limit the first image decoder.

The image generator 123 may generate the image including the semiconductor defect based on the second design information. Specifically, the image generator 123 may include a second image encoder and a second image decoder.

The second image encoder may extract the feature vector by using the second design information as an input value. Specifically, the second image encoder may extract the feature vector for the second design information, which is an image generated from the feature modifier 122B.

The second image encoder may extract the spatial, structural, or morphological features of the corresponding image as the feature vector with respect to the input second design information. Specifically, the second image encoder may provide a compressed expression space so that the second design information may be utilized as a condition for inserting a condition in a subsequent configuration or as a condition for generating an image. Accordingly, the high-dimensional image data may be compressed into an embedding format to reflect a multi-layered meaning, and the fusion between the spatial information and the conditional information may be facilitated.

In some implementations, the second image encoder may utilize various methods, such as an encoder configuration of a convolutional neural network (CNN), a vision transformer (ViT), an autoencoder, or a SAM or CLIP image encoder module. However, the above-described example does not limit the second image encoder.

The second image decoder may restore or generate the feature vector extracted from the second image encoder back into an image form based thereon. Specifically, the second image decoder may generate the image including the defect by decoding a plurality of feature vectors that combine the feature vector extracted from the second image encoder and the feature vectors for the mask received from the feature splitter 122.

In some implementations, the second image decoder may utilize various methods, such as, for example, a U-Net decoder path, a Generator decoder path of a GAN, a decoder structure of an autoencoder, or an image generation path of a diffusion model. However, the above-mentioned example does not limit the second image decoder.

In some implementations, the image generator 123 may include a fusion block. The fusion block may generate an adjusted image feature vector by the fusion of a plurality of vector information between the second image encoder and the second image decoder. Specifically, the fusion block may combine the feature vector based on the design prompt generated from the feature extractor 121 with the feature vector for the second design information generated from the second image encoder. The fusion block may conditionally combine the feature vector for the design with the second design information and modify the feature vector for the second design information.

In some implementations, the image generator 123 may include a second conditional insertion unit. The second conditional insertion unit may combine the output value of the fusion block and a noise condition. The second conditional insertion unit may increase the diversity of a defect-generating image or probabilistically adjust data such as the intensity, pattern, or location of a defect expression by combining the output value of the fusion block and the above noise condition.

For example, the above noise condition can be combined with the output value of the fusion block in various ways, such as non-limiting examples such as Gaussian Noise, Uniform Noise, Perturbation Noise, Diffusion Step Noise, and Class-aware Noise. However, this is a non-limiting example and does not limit the method of noise conditions described above.

Referring to FIG. 10A and FIG. 10B, in some implementations, a defect detection device 100 may sequentially perform a feature extractor 121, a feature splitter 122A, a feature modifier 122B, and an image generator 123 to generate a defect generation image. Specifically, the defect detection device 100 may be performed by combining the defect detection devices 100 of FIG. 8 and FIG. 9 described above.

The feature extractor 121 may generate a feature vector, which is an embedding vector, by inputting a defect prompt and a design prompt and performing a language model. Specifically, the feature extractor 121 may include a word embedding unit (also referred to as “a word embedding generator”) and a text encoder. More specifically, the word embedding unit may receive a defect prompt including an information about a defect and a defect prompt including a feature of a design information to generate an embedding vector.

The text encoder may classify a feature vector for a defect and a feature vector for a design information based on the embedding vector generated from the word embedding unit. Specifically, the text encoder may be configured to receive a word embedding vector sequence output from the word embedding unit as an input to output an integrated embedding vector reflecting a contextual meaning.

The feature splitter 122A may include a text image decoder. Specifically, the text image decoder may output an image defining a defect based on the feature vector for the defect provided from the feature extractor 121.

The feature modifier 122B may generate a second design information including a modified design information based on first design information for the design image. Specifically, the feature modifier 122B may encode the first design information and combine the feature vector received from the feature extractor 121 with the feature vector for the first design information, and then generate modified second design information.

In some implementations, the feature modifier 122B may include a first image encoder, a first conditional insertion unit, and a first image decoder. Specifically, the feature modifier 122B may encode the first design information in the first image encoder and combine the feature vector received from the feature extractor 121 with the feature vector for the first design information in the first conditional insertion unit to generate the modified second design information.

The image generator 123 may include a second image encoder, a second conditional insertion unit, and a second image decoder. Specifically, the image generator 123 may encode the normal image and the second design information in the image encoder to extract the feature vector, and decode the feature vector into the high-resolution image in the image decoder. More specifically, the image encoder may extract the spatial, structural, or morphological feature of the corresponding image for each of the input normal image and the second design information as a separate feature vector.

The second image encoder may extract the feature vector by using the normal image as an input value. Specifically, the second image encoder may extract the feature vector for the normal image based on the normal image separately supplied to the image generator 123.

The second image encoder may extract the feature vector by using the second design information as an input value. Specifically, the second image encoder may extract the feature vector for the second design information, which is an image generated from the feature modifier 122B.

The second conditional insertion unit may combine the feature vector of the normal image and the feature vector for the mask generated by the feature splitter 122A. Specifically, the conditional insertion unit may generate an integrated feature vector reflecting a defect generation condition by mutually fusing the above-described plurality of feature vectors.

In some implementations, the second conditional insertion unit may combine a noise condition. Specifically, the second conditional insertion unit may be arranged subsequent to the second image encoder to combine the noise condition into the feature vector for the second design information. The second conditional insertion unit may increase the diversity of the defect-generating image or probabilistically adjust a data such as an intensity, a pattern, or a location of a defect expression by combining the noise condition with the feature vector for the second design information.

The second image decoder may restore or generate the feature vector extracted from the second image encoder back into an image form based thereon. Specifically, the second image decoder may separately decode a plurality of feature vectors that combine a condition to the feature vector for the normal image and a plurality of feature vectors that combine a condition to the feature vector for the second design information generated from the feature modifier 122B.

In some implementations, the image generator 123 may include a fusion block. The fusion block may generate an image feature vector adjusted by fusing a plurality of vector information. The plurality of vector information may be a vector information of the normal image output from the first image encoder and a feature vector output from the feature extractor. Specifically, the fusion block may be arranged between the second image encoder and the second image decoder, and may combine the feature vector generated from the feature extractor 121 with the feature vectors extracted from the second image encoder, respectively.

More specifically, the fusion block may combine a defect prompt-based feature vector provided from the feature extractor 121 with the feature vector for the normal image. Additionally, the fusion block may combine a feature vector based on the design prompt provided from the feature extractor 121 with the feature vector for the second design information. In this way, the fusion block may modify the feature vectors by conditionally combining the natural language processing-based feature vector generated from the feature extractor 121 with the feature vectors generated from the first image encoder.

Detailed descriptions of the other feature extractor 121, feature splitter 122A, feature modifier 122B, and image generator 123 may be referred to in the aforementioned FIG. 8 and FIG. 9 to the extent that they do not contradict each other.

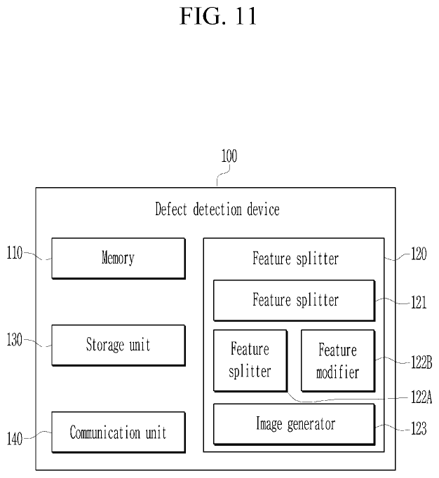

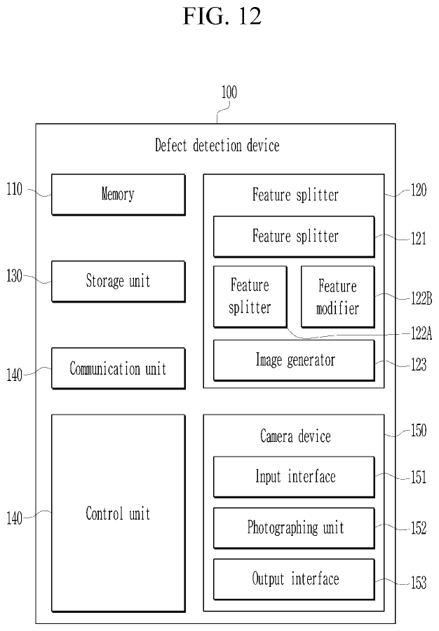

FIG. 11 and FIG. 12 are block diagrams of a defect detection device 100 according to various implementations of the present disclosure.

Referring to FIG. 11, the defect detection device 100 may include a memory 110, a processor 120, a storage unit 130, and a communication unit 140. The detailed descriptions of the memory 110, processor 120, and storage 130 may be referred to the contents described above in FIG. 1 to FIG. 10.

The communication unit 140 may perform a data communication with an external device. Specifically, the communication unit 140 may be a device including hardware and software necessary to transmit and receive signals, such as control signals or data signals, through a wired or wireless connection with other network devices.

The communication unit 140 may transmit the image information stored in the storage unit 130 of the defect detection device 100 to the outside, or receive the information from the outside to transmit the information about an image, such as a normal image or a design information, to the storage unit 130. Specifically, the storage unit 130 may receive various images, such as normal images, design images, or mask images that can be utilized by the processor 120 from the outside to be stored in the storage unit 130, and transmit the information about the second design information or the modified normal images stored in the storage unit 130 to the outside through the processor 120 to assist in utilizing the corresponding data externally.

Referring to FIG. 12, in some implementations, the defect detection device 100 may include a memory 110, a processor 120, a storage unit 130, a communication unit 140, a camera device 150, and a control unit 160.. For detailed descriptions of the memory 110, processor 120, storage 130, and communication unit 140, reference may be made to the contents described above in FIGS. 1 to 11.

The camera device 150 is a device that can directly acquire an image, such as a normal image or design information, from the storage unit 130. Specifically, the camera device 150 may obtain an image that may be utilized for the preprocessing of the defect detection device 100 or for obtaining an artificial intelligence-based input data.

The camera device 150 may obtain the normal image or the design information for the wafer at the stage where the defect detection device 100 is performed. The camera device 150 may obtain the normal image or the image for the design information and then provide it to the storage unit 130.

In some implementations, the camera device 150 may include an input interface 151, a photographing unit 152, and an output interface 153. The input interface 151 may transmit the information on a location and condition of a photographing target, such as a semiconductor wafer or a design board, to the camera device or receive an external control signal. The input interface may be implemented as an example, such as a control signal receiving port from an external automatic tester or PLC system, or a GUI control input, but the above-described examples do not limit the input interface 151.

The photographing unit 152 may directly photograph the subject. Specifically, the photographing unit may obtain an optical image by measuring a design image such as a semiconductor wafer or a design substrate. For example, the photographing unit 152 may measure the optical image by using an image sensor such as a CMOS, CCD, or high-resolution BSI sensor. However, the above-mentioned example does not limit the filming unit 152.

The output interface 153 may transmit the captured image data to the storage unit 130. The output interface 153 may link high-speed data and process it in real time to easily transmit images for artificial intelligence analysis to the storage unit 130.

The control unit 160 may control the operation of the defect detection device 100. Specifically, the control unit 160 may control the start and end of the processor 120 and control the operation between the processor 120 and the storage unit 130. In addition, the control unit 160 may control the operation of the communication unit 140 to control the transmission and reception of external data signals with the defect detection device 100.

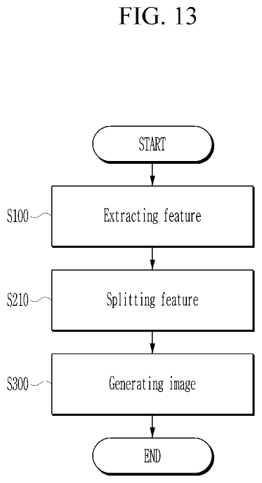

FIG. 13 is a flowchart of a defect detection method according to some implementations of the present disclosure.

Referring to FIG. 13, a defect detection method according to some implementations of the present disclosure includes a feature extraction (S100), a feature split (S210), and an image generation (S300). Specifically, the defect detection method generates an image including a defect, and splits a mask defining the defect from a language-based model and generates an image including the split mask, thereby generating a high-quality image including various types of defects.

The feature extraction (S100), the feature splitting (S210), and the image generation (S300) of FIG. 13 may be performed by the feature extractor 121, the feature splitter 122A, and the image generator 123 described above in FIG. 1 to FIG. 10, and thus the above contents may be referred to within the scope that does not contradict them.

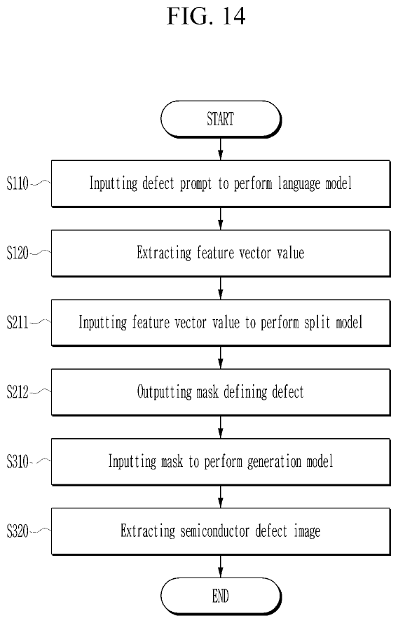

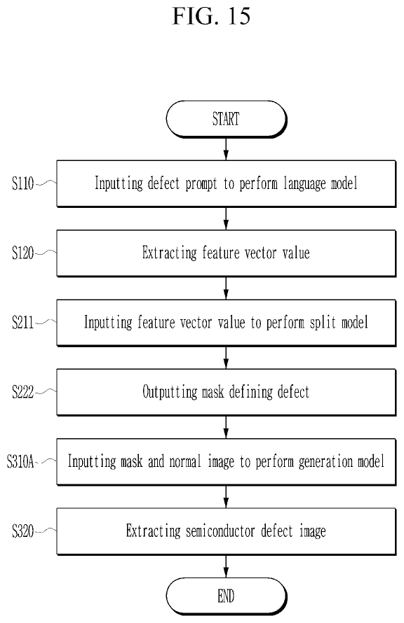

FIG. 14 and FIG. 15 are detailed flowcharts of a defect detection method of FIG. 13.

Referring to FIG. 14, the defect detection method may include performing a language model by inputting a defect prompt (S110), extracting a feature vector value (S120), performing a split model by inputting a feature vector value (S211), outputting a mask defining a defect (S212), performing a generation model by inputting a mask (S310), and extracting a semiconductor defect image (S320). Specifically, the defect detection method of FIG. 14 may be performed by the feature extractor 121, the feature splitter 122A, and the image generator 123 described above in FIG. 2 and FIG. 8, and may be referred to the above-described contents within the scope that does not contradict them.

Performing (S110) the language model by inputting the defect prompt may input the defect prompt including a defect and perform the language model. Specifically, performing (S110) the language model by inputting the defect prompt may perform a word embedding with the defect prompt as an input value to generate an embedding vector. More specifically, the language model may split the defect prompt input as a natural language sentence into a word unit, and then map each word to a vector of a fixed length to generate an embedding vector.

Extracting the feature vector value (S120) may generate a feature vector through the language model. Specifically, the feature vector for the defect may be classified based on the embedding vector. More specifically, a text encoder may be performed on the embedding vector to classify the feature vector for the defect.

Performing (S211) the split model by inputting the feature vector value may include performing a text image decoder. Specifically, performing the text image decoder may output the image defining the defect based on the feature vector obtained by performing the language model with the defect prompt as an input value.

Outputting (S212) the mask defining the defect may generate the mask obtained by performing the text image decoder. Specifically, the embedding vector may be input and the mask reflecting the visual location information of the defect may be generated.

Performing (S310) of the generation model by inputting the mask may combine the normal image and the mask. Specifically, the encoding may be performed on the normal image with the feature vector, and the feature vector for the mask may be conditionally combined with the feature vector.

In some implementations, performing (S310) the generation model by inputting the mask may generate the feature vector by encoding the feature vector for the mask. Specifically, performing (S310) the generation model may generate the feature vector by using the image for the mask as an input value.

In some implementations, performing (S310) the generative model by inputting the mask may include performing the language model with the defect prompt as an input value and fusing the extracted feature vector. Specifically, the feature vector extracted by performing the above language model may be combined with the feature vector for the mask. Accordingly, by combining the feature vector for the mask and the feature vector according to the language model, it is possible to assist in obtaining the information about the various defects in the image obtained after the decoding.

Extracting (S320) the semiconductor defect image may generate an image including the defect by decoding the plurality of feature vectors. Specifically, extracting (S320) the semiconductor defect image may include image-decoding the plurality of combined feature vectors.

Decoding the plurality of combined feature vectors into the image may restore or generate the plurality of combined feature vectors into the image form based on the combined feature vector. Specifically, decoding the image may restore or generate the image by decoding the feature vector that combines the feature vector extracted from the image encoder and the feature vector for the mask.

In some implementations, decoding the image may generate the image by decoding the feature vectors that combine not only the feature vectors described above in the mask, but also the feature vectors generated by performing the language model based on the defect prompt. In this way, by decoding multiple feature vectors, the high-quality image including the defect mask may be generated.

Referring to FIG. 15, the defect detection method may include performing a language model by inputting a defect prompt (S110), extracting a feature vector value (S120), performing a split model by inputting the feature vector value (S211), outputting a mask defining a defect (S212), performing a generation model by inputting the mask and a normal image (S310A), and extracting a semiconductor defect image (S320). Specifically, the defect detection method of FIG. 15 may be performed by the feature extractor 121, the feature splitter 122A, and the image generator 123 described above in FIG. 2 and FIG. 8, and the above-described contents may be referred within the scope that does not contradict them. In addition, FIG. 5 is different from FIG. 14 in that the generation model is performed by additionally using the normal image, and this difference will be described later.

In some implementations, performing (S310A) the generation model by inputting the mask and the normal image may include performing the image encoder by inputting the normal image and t conditionally combining the feature vector for the mask with the feature vector for the normal image.

Performing the image encoder by inputting the normal image may extract the spatial, structural, or morphological feature of the normal image as a feature vector. Specifically, the normal image may be provided as a compressed expression space so that it may be utilized for inserting a condition in a subsequent step or as a condition for generating an image.

Conditionally combining the feature vector for the mask with the feature vector for the normal image may combine the feature vector for the normal image and the feature vector for the mask generated by performing the split model. Specifically, by mutually fusing the multiple feature vectors, an integrated feature vector reflecting the defect generation condition may be generated.

In some implementations performing (S310A) the generation model by inputting the mask and the normal image may include performing a language model with a defect prompt as an input value to fuse the extracted feature vector. Specifically, fusing the feature vector may combine the feature vector extracted by performing the language model on the feature vector generated by image encoding for the normal image.

In some implementations, fusing the feature vector may be performed between encoding the feature vector for the normal image and combining the feature vector for the mask into the feature vector. Accordingly, by conditionally preprocessing the feature vector of the normal image by modifying it partially based on the feature vector according to the language model before combining the feature vector for the mask, the information on the various defects in the subsequently obtained image may be obtained.

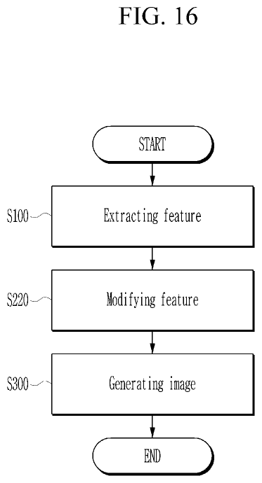

FIG. 16 is a flowchart of a defect detection method according to some implementations of the present disclosure.

Referring to FIG. 16, a defect detection method according to some implementations of the present disclosure includes a feature extraction (S100), a feature modification (S220), and an image generation (S300). Specifically, the defect detection method may generate an image including a defect, generate a feature vector from a language-based model, modify a design information including a design image based on the feature vector, and generate a high-quality image including various types of defects based on the modified design information.

The feature extraction (S100), the feature modification (S220), and the image generation (S300) of FIG. 16 may be performed by the feature extractor 121, the feature modifier 122B, and the image generator 123 described above in FIG. 1 to FIG. 10, and thus the above contents may be referred to within the scope that does not contradict them.

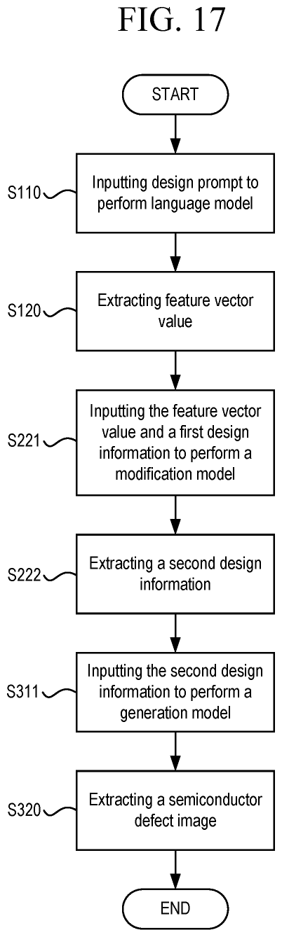

FIG. 17 is a detailed flowchart of the defect detection method of FIG. 16.

Referring to FIG. 17, the defect detection method may include performing a language model by inputting a design prompt (S110), extracting a feature vector value (S120), performing a modification model by inputting the feature vector value and a first design information (S221), extracting a second design information (S222), performing a generation model by inputting the second design information (S311), and extracting a semiconductor defect image (S320). Specifically, the defect detection method of FIG. 17 is performed by the feature extractor 121, the feature modifier 122B, and the image generator 123 described above in FIG. 3 and FIG. 9, and the above-described contents may be referred within the scope that does not contradict them.

Performing (S110) the language model by inputting the design prompt may execute the language model by inputting the design prompt including the feature for the design information. Specifically, performing (S110) the language model by inputting the design prompt may perform a word embedding with the design prompt as an input value to generate the embedding vector. More specifically, the language model may divide the design prompt input as a natural language sentence into a word unit, and then map each word to a vector of a fixed length to generate the embedding vector.

Extracting the feature vector value (S120) may generate the feature vector through the language model. Specifically, the feature vector for the design information may be classified based on the embedding vector. More specifically, the text encoder may be performed on the embedding vector to classify the feature vector for the defect.

Performing (S221) the modification model by inputting the feature vector value and the first design information may generate the second design information including the design information modified based on the first design information for the design image. Specifically, performing (S221) the modification model may encode the first design information to generate the feature vector and combine the feature vectors generated in extracting (S120) the feature vector value.

In some implementations, performing (S221) the modification model by inputting the feature vector value and the first design information may include encoding the first design information, and combining the feature vector generated in extracting the feature vector value into the feature vector for the first design information. Encoding the first design information may extract the spatial, structural, or morphological feature of the corresponding image as a feature vector with respect to the first design information. Specifically, the first design information may provide a compressed expression space that may be utilized for inserting a condition or as a condition generating an image in a subsequent step.

Combining the feature vector generated in extracting the feature vector value for the feature vector for the first design information may mutually fuse the feature vector of the first design information and the feature vector generated through the language model. Accordingly, the feature vector may be generated to include the defect defined as an area that deviate from a pattern type and a modification characteristic, which are features of the design information input as a language model in the first design information.

As above described, by combining the feature vector generated through the language model as a condition to the feature vector for the first design information, it is possible to generate the feature vector that may clearly and structurally respond to even subtle defects that are difficult to distinguish with only the first design information or the abstract defect condition defined in the text without the fixed condition.

Extracting the second design information (S222) may include image-decoding the aforementioned feature vector. Through the image decoding, the feature vector generated through the language model is combined to the first design information as a condition, thereby generating the modified second design information.

Performing (S311) the generation model by inputting the second design information may include performing the image encoder by inputting the second design information. Performing the image encoder may generate the feature vector by performing the image encoder with the second design information as an input value. Specifically, performing (S311) the generation model may generate the feature vector by using the image for the second design information as an input value.

Performing (S311) the generation model by inputting the second design information includes merging the feature vector obtained from the language model. Specifically, the feature vector extracted by performing the language model may be combined with the feature vector for the second design information. Accordingly, by combining the feature vector for the second design information and the feature vector for the language model, it is possible to assist in obtaining the information on the various defects in the image obtained after the decoding.

In some implementations, performing (S311) the generation model by inputting the second design information may include adding a noise condition. Specifically, performing the generative model may combine the noise condition to the above-mentioned feature vector. More specifically, the feature vector for the noise condition may be conditionally combined to the feature vector in which the feature vector for the language model is combined to the vector for the second design information. This allows for increasing the diversity of the defect generative images, or probabilistically controlling the data such as the intensity, pattern, or location of defect expressions.

Extracting (S320) the semiconductor defect image may generate the image including the defect by decoding the plurality of feature vectors. Specifically, extracting (S320) the semiconductor defect image may include image-decoding the plurality of combined feature vectors.

Decoding the plurality of combined feature vectors into the image may again restore or generate the feature vector of which the plurality of feature vectors are combined into the image form based thereon. Specifically, the image-decoding may decode the feature vector that combines the feature vector generated through the modification model, the feature vector generated through the language model, and the feature vector for the noise condition to be restored or generated in the form of the image.

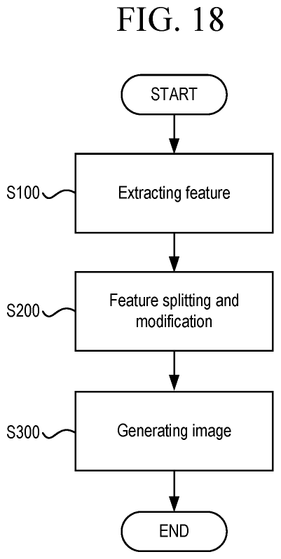

FIG. 18 is a flowchart of a defect detection method according to some implementations of the present disclosure.

Referring to FIG. 18, a defect detection method according to some implementations of the present disclosure includes a feature extraction (S100), a feature split and modification (S200), and an image generation (S300). Specifically, the defect detection method is to generate an image including a defect, and may generates a feature vector for the defect and a feature vector for the design from a language-based model, and generate a mask or change a design information through a split and modification model, thereby generating a high-quality image including various types of defects.

The feature extraction (S100), the feature split and modification (S200), and the image generation (S300) of FIG. 18 may be performed by the feature extractor 121, the feature splitter 122A, the feature modifier 122B, and the image generator 123 described above in FIG. 1 to FIG. 10, and thus the above contents may be referred within the scope that does not contradict them.

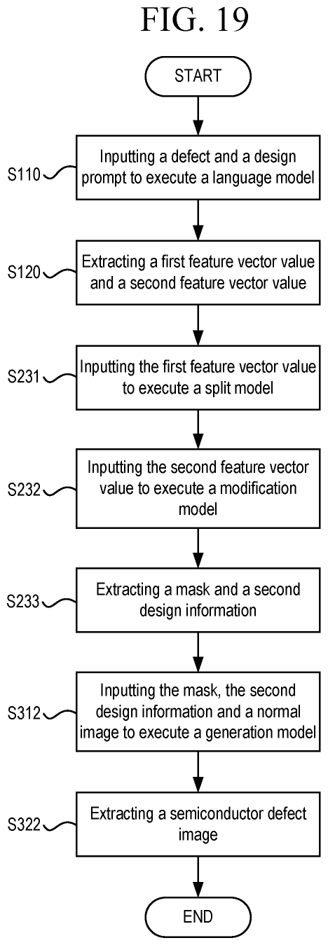

FIG. 19 is a detailed flowchart of a defect detection method of FIG. 18.

Referring to FIG. 19, the method may include executing a language model by inputting a defect and a design prompt, respectively (S110), extracting a first feature vector value and a second feature vector value (S120), executing a split model by inputting the first feature vector value (S231), executing a modification model by inputting the second feature vector value and the first design information (S232), extracting a mask and a second design information (S233), executing a generation model by inputting the mask, the second design information, and a normal image (S312), and extracting a semiconductor defect image (S322).

Performing (S110) the language model by inputting the defect and the design prompt respectively may input the defect prompt including the defect and the design prompt including the design information and perform the language model respectively. Specifically, performing the language model (S110) may perform a word embedding on each of the defect prompt and the design prompt to generate an embedding vector, respectively.

Extracting the first feature vector value and the second feature vector value (S120) may be performed by inputting the defect prompt and executing the language model to generate the first feature vector value, and may be performed by inputting the design prompt and executing the language model to generate the second feature vector value. Specifically, based on the embedding vector generated in performing the language model (S110), the first feature vector, which is the feature vector for the defect, and the second feature vector, which is the feature vector for the design information, may be classified.

Performing the split model by inputting the first feature vector value (S231) may include performing a text image decoder. Specifically, performing the text image decoder may output the image defining the defect based on the feature vector obtained by performing the language model with the defect prompt as an input value.

In some implementations, performing the split model by inputting the first feature vector value (S231) may include performing the text image decoder. Specifically, performing the split model (S231) may output the image defining the defect based on the first feature vector.

Performing the modification model by inputting the second feature vector value and the first design information (S232) may generate the second design information including the modified design information based on the first design information for the design image. Specifically, performing the modification model (S232) may include encoding the first design information and combining the feature vectors generated in extracting the feature vector values for the feature vector for the first design information. The detailed explanation of this may be referred to the contents described above in FIG. 17.

Extracting the mask and second design information (S233) may generate the mask for the defect generated through the split model and the second design information generated through the modification model as an image, respectively. Specifically, the mask may be generated by performing the text image decoding in the split model. The second design information may be generated by performing the image decoding on the modified model.

Performing the generation model by inputting the mask, the second design information, and the normal image (S312) may include performing the image encoder, merging the feature vector obtained from the language model, combining the specific condition, and performing the image decoder. Specifically, performing the generation model (S312) may obtain the image including the defect by combining and encoding and decoding the feature vector of the mask and the normal image, and may obtain the image including the defect by encoding and decoding the feature vector of the second design information.

Performing the image encoder may encode the normal image and the second design information as input values to generate each feature vector. Specifically, performing the image encoder may provide a compressed expression space such that the normal image and the second design information may be utilized for inserting a condition in a subsequent configuration or as a condition for generating the image.

Fusing the feature vector obtained from the language model may fusion the feature vector obtained from the language model with the feature vector value passed through the image encoder. Specifically, the feature vector generated based on the defect prompt may be fused to the feature vector for the normal image, and the feature vector generated based on the defect prompt may be fused to the feature vector for the second design information.

Combining the specific condition may conditionally combine the feature vector of the mask image generated from the split model with the feature vector for the normal image. Specifically, combining the specific condition may combine the feature vector of the mask image generated from the split model with the feature vector for the normal image into which the feature vector obtained from the language model is fused. Accordingly, the image including the high-quality defect may be obtained in a subsequent step.

In some implementations, combining the specific condition may combine a noise condition to the feature vector for the second design information. Therefore, the diversity of the defect-generating image may be increased or the data such as the intensity, pattern, or location of the defect expression may be probabilistically modulated.

Extracting the semiconductor defect image (S322) may include performing an image decoder. Performing the above image decoder may restore or generate the feature vector extracted from the image encoder back into the form of the image based thereon. Specifically, performing the image decoder may generate the feature vectors obtained through performing the image encoder, fusing the feature vectors obtained from the language model, and combining the specific conditions described above as images, respectively.

More specifically, one of the images that has gone through performing the image decoder may be generated as an image modified by the feature vector generated based on the defect prompt in the feature vector of the normal image and the feature vector for the mask. Another image that has gone through performing the image decoder may be generated as an image modified by the feature vector generated based on the design prompt and the noise condition in the feature vector of the second design information.

Some implementations may be represented by functional block configurations and various steps. These functional blocks may be implemented as any number of hardware and/or software configurations that perform specific functions. For example, some implementations may employ direct circuit configurations such as memory, processing, logic, look-up tables, etc. that may execute various functions under the control of one or more microprocessors or other control devices.

Similarly to how components may be implemented as software programs or software elements, the present implementations may be implemented in a programming or scripting language, such as C, C++, Java, Assembler, etc., including various algorithms implemented as a combination of data structures, processes, routines, or other programming constructs. Functional aspects may be implemented as algorithms running on one or more processors.

Additionally, some implementations may employ conventional techniques for electronic environment settings, signal processing, and/or data processing. Terms such as “mechanism,” “element,” “means,” and “composition” can be used broadly and are not limited to mechanical and physical structures. The above term may include the meaning of a series of software processes (routines) in connection with a processor, etc.

Any use of examples or exemplary language herein is intended merely to elaborate the disclosure and does not limit the scope of the disclosure. Additionally, one of ordinary skill in the art will recognize that various modifications, combinations, and changes can be made within the scope of the patent claims or their equivalents.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While this disclosure has been described in connection with what is presently considered to be practical exemplary implementations, it is to be understood that the disclosure is not limited to the disclosed implementations, but, on the contrary, is intended to cover various modifications and equivalent arrangements included within the spirit and scope of the appended claims.

What is claimed is:

1. A defect detection device comprising:
a memory configured to store machine learning models; and
a processor configured to execute the machine learning models,
wherein the processor includes
a feature extractor configured to generate a feature vector based on information of a defect;
a feature splitter configured to generate a mask defining the defect based on the feature vector; and
an image generator configured to generate a normal image and an image including a semiconductor defect from the mask.

2. The defect detection device of claim 1, wherein:
the feature extractor includes
a word embedding generator configured to receive a prompt including information of the defect and generate an embedding vector; and
a text encoder configured to classify the feature vector based on the embedding vector.

3. The defect detection device of claim 2, wherein:
the prompt including the information of the defect comprises a text prompt including at least one of a type, a location, a size, or a number of the defect.

4. The defect detection device of claim 2, wherein:
the embedding vector is generated based on inputting the prompt including the information of the defect to a natural language processing model.

5. The defect detection device of claim 4, wherein:
the natural language processing model is configured to generate a context-based embedding based on a transformer-based language model.

6. The defect detection device of claim 4, comprising:
a multimodal model configured to generate a multimodal embedding vector based on combining the prompt including the information of the defect and a semiconductor image.

7. The defect detection device of claim 1, wherein:
the feature splitter is configured to receive the feature vector generated by the feature extractor as a condition and generate a defect mask including a defect location in a pixel unit of a semiconductor image.

8. The defect detection device of claim 1, wherein:
the feature splitter includes a text-image decoder, and
the text-image decoder outputs a mask defining the defect based on the feature vector as an image.

9. The defect detection device of claim 1, wherein:
the feature splitter includes a multi-stage split structure configured to gradually refine and output a mask defining the defect based on the feature vector.

10. The defect detection device of claim 1, wherein:
the image generator includes
an image encoder configured to receive a normal image as an input value and output a feature vector of the normal image; and
an image decoder configured to generate a defective image based on a vector information, wherein the vector information is a combination of information of the mask generated by the feature splitter and the feature vector of the normal image;

11. The defect detection device of claim 10, wherein:
the image generator includes a fusion block configured to fuse a plurality of vector information between the image encoder and the image decoder and generate an adjusted image feature vector.

12. The defect detection device of claim 11, wherein:
the plurality of vector information is vector information of a normal image generated by the image encoder and a feature vector generated by the feature extractor.

13. The defect detection device of claim 11, comprising:
a conditional insertion circuit between the image encoder and the image decoder, the condition insertion circuit configured to combine the feature vector of the normal image and the feature vector of the mask.

14. The defect detection device of claim 11, wherein:
the image generator is configured to receive the feature vector generated by the feature extractor and generate an image including a semiconductor defect as an output value.

15. A defect detection device comprising:
a memory configured to store machine learning models; and
a processor configured to execute operations related to the machine learning models,
wherein the processor includes
a feature extractor configured to generate a feature vector based on a feature of a first design information;
a feature modifier configured to generate a second design information by modifying the first design information comprising a design image for a wafer in a semiconductor manufacturing process, based on the feature vector; and
an image generator configured to generate an image including a semiconductor defect based on the second design information.

16. The defect detection device of claim 15, wherein:
the feature modifier includes
a first image encoder configured to generate a feature vector based on the first design information;
a first conditional insertion circuit configured to combine the feature vector generated by the feature extractor with the feature vector generated based on the first design information and generate a combined vector information; and
a first image decoder configured to generate the second design information based on the combined vector information;

17. The defect detection device of claim 16, wherein:
the image generator includes
a second image encoder configured to output a feature vector based on the second design information; and
a second image decoder configured to generate a defective image based on the feature vector generated by the second image encoder;

18. The defect detection device of claim 17, comprising:
a fusion block between the second image encoder and the second image decoder, the fusion block configured to generate an adjusted image feature vector based on a fusion of the feature vector generated by the second image encoder and the feature vector generated by the feature extractor.

19. The defect detection device of claim 18, wherein:
the image generator includes a second conditional insertion circuit configured to combine an output value of the fusion block with a noise condition.

20. A defect detection device comprising:
a memory configured to store machine learning models; and
a processor configured to execute the machine learning models,
wherein the processor comprises
a feature extractor configured to generate a first feature vector based on information of a defect and a second feature vector based on a feature of a design information;
a feature splitter configured to output a mask defining the defect based on the first feature vector;
a feature modifier including
a first image encoder configured to generate a feature vector based on a first design information, wherein the first design information comprises a design image for a wafer in a semiconductor manufacturing process,
a first conditional insertion circuit configured to combine the second feature vector with the feature vector for the first design information and generate a combined vector information, and
a first image decoder configured to generate a second design information based on the combined vector information; and
an image generator including
a second image encoder configured to output a feature vector based on a normal image and a second design information,
a second conditional insertion circuit configured to combine information of the mask generated by the feature splitter and the feature vector generated by the second image encoder and generate combined vector information, and
a second image decoder configured to generate a defective image based on the combined vector information.
